(19) United States
(12) Patent Application Publication
(10) Pub. No.: US 2013/0236055 A1
(43) Pub. Date: Sep. 12, 2013

(54) IMAGE ANALYSIS DEVICE FOR CALCULATING VECTOR FOR ADJUSTING A COMPOSITE POSITION BETWEEN IMAGES

(71) Applicant: CASIO COMPUTER CO., LTD., Tokyo (JP)

(72) Inventors: Naotomo MIYAMOTO, Tokyo (JP); Kosuke MATSUMOTO, Tokyo (JP)

(73) Assignee: CASIO COMPUTER CO., LTD., Tokyo (JP)

(21) Appl. No.: 13/787,411

(22) Filed: Mar. 6, 2013

(30) Foreign Application Priority Data
Mar. 8, 2012 (JP) 2012-051169

(51) Int. Cl. G06T 7/00

(52) U.S. Cl. CPC G06T 7/0042
USPC 382/103

(57) ABSTRACT

The image processing device 1 includes an image acquiring unit 54 that acquires a first image and a second image captured by an image capture unit, while the image capture unit is moved substantially in a single direction; a characteristic point tracking unit 551 that, for a plurality of characteristic points included in each of the images acquired, calculates vectors between the images having the characteristic points; a distribution calculation unit 552 that calculates a distribution condition of the vectors calculated; and a moving amount calculation unit 553 that calculates a representative vector for adjusting a composite position between the images, by weighting vectors calculated based on a calculation result of the distribution calculation unit.

This application is based on and claims the benefit of priority from Japanese Patent Application No, 2012-051169, filed on 8 Mar. 2012, the content of which is incorporated herein by reference.

### BACKGROUND OF THE INVENTION

1. Field of the Invention

The present invention relates to an image analysis device, an image processing device, an image analysis method, and a storage medium for calculating vectors for adjusting a composite position between images.

2. Related Art

In digital cameras, portable telephones having an image capture function, and the like, the limit of the image capture angle of view depends on the hardware specifications provided by the device main body, such as the focal distance of the lens and size of the imaging elements. Therefore, conventionally, panorama photography has been developed for obtaining a wide-angle image exceeding the hardware specifications, for example.

FIGS. 7A and 7B is a view illustrating a panorama image acquired from panorama photography. With reference to FIGS. 7A and 7B, in order to realize the aforementioned panorama photography, a user moves so as to cause the digital camera to rotate horizontally about their body while keeping substantially fixed in the vertical direction, while maintaining a state making a pressing operation on the shutter switch, for example. Thereupon, the digital camera executes image capture processing a plurality of times in this period and captures a plurality of consecutive images F1, F2, F3, and F4 illustrated in FIG. 7A. In panorama photography, data of a panorama image P1 illustrated in FIG. 7B is generated by combining the respective data of the plurality of images F1 to F4 thus captured in a panorama photography (horizontal) direction.

Here, for generating data of the panorama image P1, it is necessary to combine the respective data upon adjusting a composite position between adjacent images among the images F1 to F4 (for example, images F1 and F2), and conventionally technology has been known that adjusts a composite position adjacent images using the image analysis technique called RANSAC (RANdom SAmple Consensus) (M. A. Fischler and R. C. Bolles, “Random sample consensus: A paradigm for model fitting with applications to image analysis and automated cartography,” Commun. ACM, No. 24, Vol. 6, pp. 381 {395, June 1981}). In regards to RANSAC, for example, Japanese Unexamined Patent Application No. 2011-65371, Publication discloses technology of adjusting a composite position between images to be combined by calculating a transformation matrix of corresponding characteristic points between the images to be combined upon combining the images.

### SUMMARY OF THE INVENTION

An image processing device according to an aspect of the present invention includes: an acquiring unit that acquires a first image and a second image captured by an image capture unit, while the image capture unit is moved substantially in a single direction; a vector calculation unit that, for a plurality of characteristic points included in each of the images acquired by the acquiring unit, calculates vectors between the images having the characteristic points; a distribution calculation unit that calculates a distribution condition of the vectors calculated by the vector calculation unit; and a representative vector calculation unit that calculates a representative vector for adjusting a composite position between the images, by weighting vectors calculated by the vector calculation unit based on a calculation result of the distribution calculation unit.

An image analysis method according to an aspect of the present invention includes the steps of: acquiring a first image and a second image captured by an image capture unit, while the image capture unit is moved substantially in a single direction; for a plurality of characteristic points included in each of the images acquired by the acquiring unit, calculating vectors between the images having the characteristic points; calculating a distribution condition of the vectors calculated by the vector calculation unit; and calculating a representative vector for adjusting a composite position between the images, by weighting vectors calculated by the vector calculation unit based on a calculation result of the distribution calculation unit.

A storage medium according to an aspect of the present invention is a storage medium encoded with a computer-readable program that enables a computer to execute functions as: an acquiring unit that acquires a first image and a second image captured by an image capture unit, while the image capture unit is moved substantially in a single direction; a vector calculation unit that, for a plurality of characteristic points included in the images acquired by the acquiring unit, calculates a vector between the images having the characteristic points; a distribution calculation unit that calculates a distribution condition of the vectors calculated by the vector calculation unit; and a representative vector calculation unit that calculates a representative vector for adjusting a composite position between the images, by weighting vectors calculated by the vector calculation unit based on a calculation result of the distribution calculation unit.

### BRIEF DESCRIPTION OF THE DRAWINGS

FIG. 1 is a block diagram illustrating a hardware configuration of an image processing device according to an embodiment of the present invention;

FIG. 2 is a functional block diagram illustrating a functional configuration for executing panorama image generation processing, among the functional configurations of the image processing device of FIG. 1;

FIGS. 3A and 3B are charts illustrating a function of an adjustment unit of an image processing unit;

FIG. 4 is a chart illustrating a function of an adjustment unit of an image processing unit;

FIG. 5 are views illustrating an adjustment of adjacent captured images by an adjustment unit of an image processing unit;

FIG. 6 is a flowchart illustrating a flow of a panorama image generation processing executed by the image processing device of FIG. 1 having the functional configuration of FIG. 2; and

FIGS. 7A and 73 are views illustrating a panorama image acquired as a result of panorama photography.

### DETAILED DESCRIPTION OF THE INVENTION

Hereinafter, embodiments relating to the present invention will be explained while referencing the drawings.

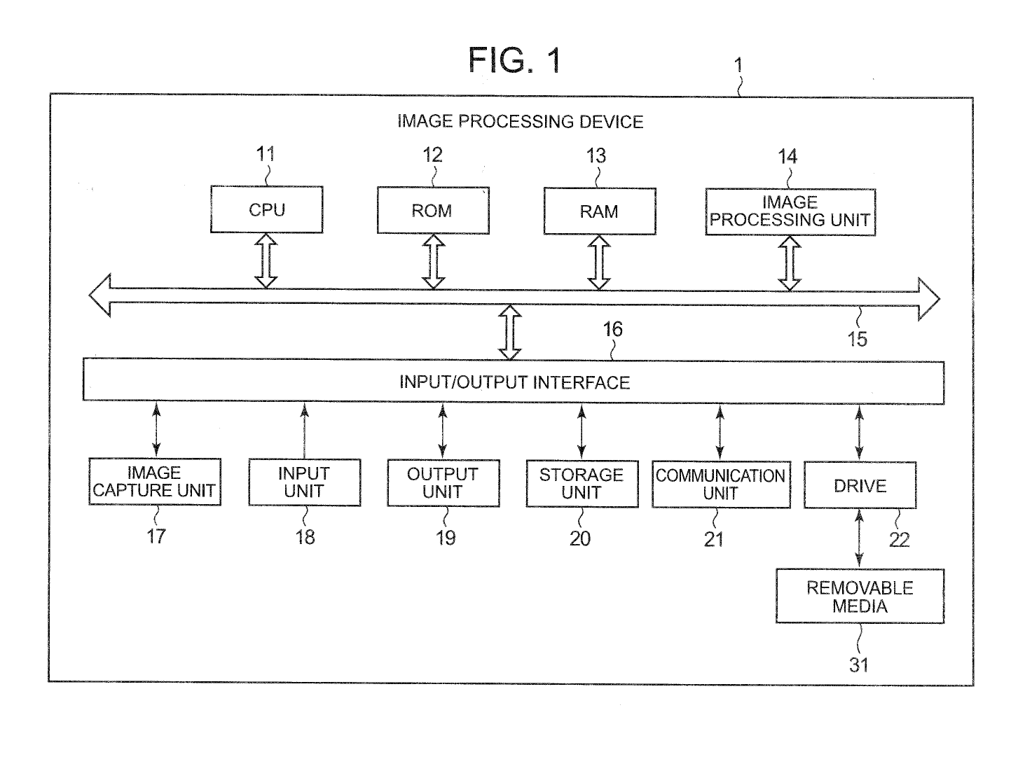

FIG. 1 is a block diagram illustrating a hardware configuration of an image processing device 1 according to an embodiment of the present invention.

The image processing device 1 is configured as a digital camera 1, for example.

The image processing device 1 includes a CPU (Central Processing Unit) 11, a ROM (Read Only Memory) 12, a RAM (Random Access Memory) 13, an image processing unit 14, a bus 15, an input/output interface 16, an image capture unit 17, an input unit 18, an output unit 19, a storage unit 20, a communication unit 21, and a drive 22.

The CPU 11 executes various processing in accordance with programs stored in the ROM 12, or programs loaded from the storage unit 20 into the RAM 13.

The RAM 13 stores the necessary data and the like upon the CPU 11 executing various processing, as appropriate.

The image processing unit 14 is composed of a DSP (Digital Signal Processor), VRAM (Video Random Access Memory), and the like, and cooperates with the CPU 11 to execute various image processing on image data.

The CPU 11, the ROM 12, and the RAM 13 are connected to each other via the bus 15. The input/output interface 16 is also connected to the bus 15. The image capture unit 17, the input unit 18, the output unit 19, the storage unit 20, the communication unit 21, and the drive 22 are also connected to the input/output interface 16.

The image capture unit 17 (not illustrated) includes an optical lens unit and an image sensor.

The optical lens unit is configured by a lens that condenses light in order to capture an image of a subject, e.g., a focus lens, zoom lens, etc. The focus lens is a lens that causes a subject image to form on a light receiving surface of an image sensor. The zoom lens is a lens that causes the focal length to freely change in a certain range. Peripheral circuits that adjust the setting of parameters such as focus, exposure and white balance are also provided to the optical lens unit as necessary.

The image sensor is configured from photoelectric conversion elements, AFE (Analog Front End), etc. The photoelectric conversion elements are configured from CMOS (Complementary Metal Oxide Semiconductor)-type photoelectric conversion elements. A subject image is reflected from the optical lens unit to the photoelectric conversion elements. There, the photoelectric conversion elements perform photoelectric conversion of a subject image (captures an image) to accumulate image signals for a certain time period and sequentially supply the image signals thus accumulated to AFE as analog signals.

The AFE conducts various signal processing such as A/D (Analog/Digital) conversion processing on these analog image signals. Digital signals are generated through various signal processing and outputted as output signals of the image capture unit 17.

Such output signals of the image capture unit 17 are hereinafter called “captured image data”. The captured image data is supplied to the CPU 11, the image processing unit 14, and the like as appropriate.

The input unit 18 is configured by various buttons such as a shutter switch and inputs various information or instructions in accordance with a user's operations.

The output unit 19 is configured by a display, a speaker, and the like and outputs images and sounds.

The storage unit 20 is configured by a hard disk, DRAM (Dynamic Random Access Memory), and the like, and stores various image data.

The communication unit 21 controls communication with other devices (not illustrated) via networks including the Internet.

A removable media 31 made from a magnetic disk, optical disk, magneto-optical disk, semiconductor memory, or the like is installed in the drive 22 as appropriate. The programs read from the removable media 31 by the drive 22 are installed in the storage unit 20 as necessary. In addition, similarly to the storage unit 20, the removable media 31 can also store various data such as the image data stored in the storage unit 20.

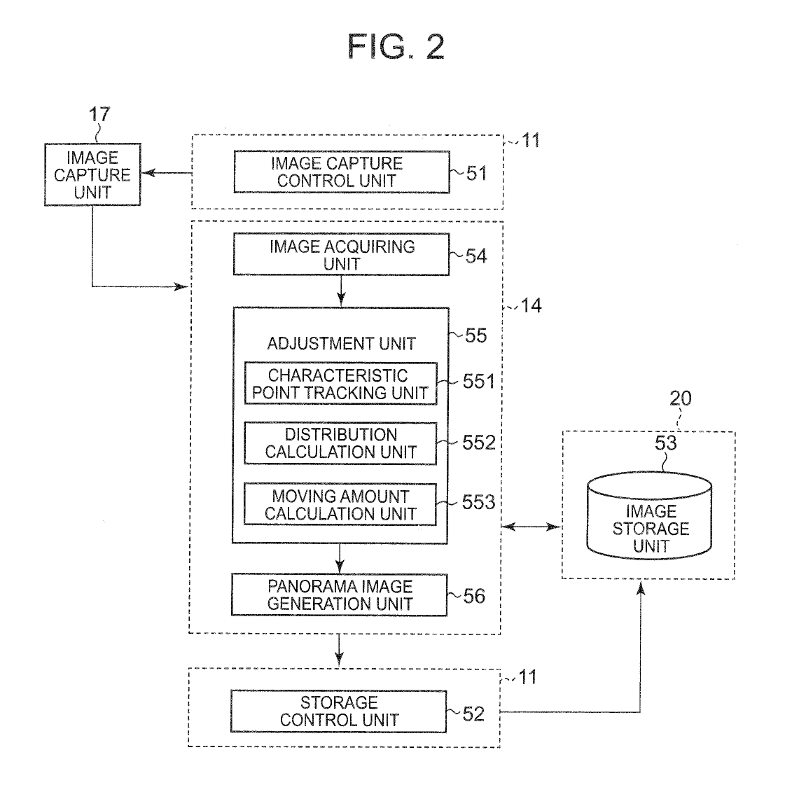

FIG. 2 is a functional block diagram illustrating a functional configuration for executing panorama image generation processing, among the functional configurations of the image processing device 1. Here, “panorama image generation processing” refers to processing that generates panorama image data using data of a plurality of captured images acquired consecutively. It should be noted that “panorama image” is an example of a horizontally-long or a vertically-long wide-angle image, as compared with an image with the aspect ratio of 2:3 photographed by 35 mm film or an image with the aspect ratio of 3:4 photographed by a digital camera.

When the image processing device 1 executes panorama image generation processing, the CPU 11 serves as an image capture control unit 51 and a storage control unit 52. In this case, an image storage unit 53 is provided as an area that stores various image data such as captured image data and panorama image data.

The image capture control unit 51 controls various image capture operations by the image capture unit 17.

More specifically, when a user presses the shutter switch of the input unit 18 while holding the image processing device 1 as a digital camera, the image processing device 1 starts the panorama image generation processing. Upon starting the panorama image generation processing, the image capture control unit 51 starts a consecutive image capture operation of the image capture unit 17, and captures an image each time a certain period of time elapses or each time the image processing device 1 is moved a certain amount.

During this, if a predetermined condition is satisfied such as when the state of the user maintaining the pressing of the shutter switch having continued for a certain period of time or when the digital camera has been moved a certain amount, the image capture control unit 51 ends the consecutive image capture operation in the image capture unit 17 and ends the panorama image generation processing.

The storage control unit 52 executes control to cause various image data such as panorama image data generated from a result of panorama image generation processing to be stored in the image storage unit 53.

Furthermore, when the image processing device 1 executes the panorama image generation processing, the image processing unit 14 serves as an image acquiring unit 54, an adjustment unit 55, and a panorama image generation unit 56.

The image acquiring unit 54 sequentially acquires data of a plurality of captured images outputted by the consecutive image capture operation of the image capture unit 17, i.e. data of a plurality of images that are consecutively captured.

The adjustment unit 55 performs adjustment processing between adjacent captured images among the plurality of captured images, with each of the plurality of captured image data acquired by the image acquiring unit 54 as a processing target. It should be noted that the adjacent captured images here refer to an n-th captured image (n is an integer value of at least 1) and an n+1-th captured image among the plurality of captured images that are consecutively captured.

Here, in the present embodiment, the adjustment processing between the adjacent captured images is realized by a method different from RANSAC method, which has been generally used conventionally. Therefore, the adjustment unit 55 of the present embodiment is configured to include a characteristic point tracking unit 551, a distribution calculation unit 552, and a moving amount calculation unit 553.

The characteristic point tracking unit 551 detects a plurality of characteristic points among captured images, with data of each of a plurality of captured images acquired by the image acquiring unit 54 as a processing target, and calculates a so-called moving vector, which indicates how the characteristic points move in the adjacent captured images for each of the plurality of characteristic points. That is to say, the characteristic point tracking unit 551 calculates vectors of the plurality of characteristic points in the adjacent captured images each time the image acquiring unit 54 acquires captured image data. More specifically, as soon as the image acquiring unit 54 acquires the n-th captured image data, the characteristic point tracking unit 551 detects a plurality of characteristic points within the n-th captured image data and temporarily stores them in the image storage unit 53. Then, the characteristic point tracking unit 551 detects a plurality of characteristic points within the n+1-th captured image as soon as the image acquiring unit 54 acquires the n+1-th captured image data, specifies corresponding points from among the characteristic points in the n-th captured image temporarily stored for each of the plurality of characteristic points of the n+1-th captured image data, and calculates a vector from the corresponding point to the characteristic point as a vector of the characteristic point. At this time, the characteristic point tracking unit 551 associates the characteristic points of the n+1-th captured image data and the vector thus calculated with the n+1-th captured image data and stores in the image storage unit 53. It should be noted that vector in the present embodiment indicates a moving direction and an amount of moving distance of a characteristic point.

Here, a publicly known method can be employed for a method for detecting a characteristic point within a captured image, and, for example, SIFT (Scale Invariant Feature Transform), Harris Corner Detection, or another method may be employed.

With vectors of a characteristic point between adjacent captured images calculated by the characteristic point tracking unit 551, i.e. vectors of a plurality of characteristic points of the n+1-th captured image with respect to the n-th captured image as a processing target, the distribution calculation unit 552 calculates a distribution condition of the vectors. Here, the calculation of the distribution condition is conducted by classifying each of a plurality of characteristic points into a plurality of classes based on the magnitude of the vector, and extracting the number of characteristic points belonging to each of the plurality of classes as a result of the classification (number equivalent to the number of vectors of a magnitude belonging to each class). As an example, in the present embodiment, the distribution calculation unit 552 calculates the distribution condition using a histogram. At this time, the distribution calculation unit 552 calculates the distribution condition of vectors in a horizontal direction (hereinafter, “x-direction”) and a vertical direction (hereinafter, “y-direction”), respectively.

Here, the plurality of classes that classify characteristic points can be arbitrarily set. For example, the distribution calculation unit 552 may set a plurality of classes based on a value calculated by dividing a difference between the maximum value and the minimum value of the magnitude of a vector by a predetermined number (for example, divided by 64). With such a setting, as the maximum value and the minimum value of a vector differ more from each other, the width of a class gets broader and the class becomes rough. On the other hand, as the maximum value and the minimum value of a vector become more proximate, the width of a class gets narrower and the class becomes detailed. Naturally, the present invention is not limited to such a setting, and the distribution calculation unit 552 may classify characteristic points by classes of constant width regardless of the difference between the maximum value and the minimum value of a vector.

The moving amount calculation unit 553 calculates the dislocation between adjacent captured images from a vector of the characteristic points between adjacent captured images, i.e. a vector of the n+1-th captured image with respect to the n-th captured image. At this time, in order to reduce arithmetic processing compared to conventional RANSAC, the moving amount calculation unit 553 calculates a vector of the n+1-th captured image by calculating an approximate average of vectors of a plurality of characteristic points. More specifically, the moving amount calculation unit 553 calculates a vector of the n+1-th captured image by calculating a weighted average using the number of the characteristic points belonging to the same class as a weight, as shown in the following formulae 1 and 2.

$$\begin{matrix}{X}_{GMV} = \frac{{\sum }_{m = 0}^{n} ( {X}_{m} * {P}_{m} )}{{\sum }_{m = 0}^{n} {P}_{m}} & Formula 1 \\ {Y}_{GMV} = \frac{{\sum }_{m = 0}^{n} ( {Y}_{m} * {Q}_{m} )}{{\sum }_{m = 0}^{n} {Q}_{m}} & Formula 2\end{matrix}$$

X_{GMV}: Magnitude in x-direction of vector of captured image
Y_{GMV}: Magnitude in y-direction of vector of captured image
Xm: Magnitude in x-direction of vector of characteristic point of the m-th captured image
Ym: Magnitude in y-direction of vector of m-th characteristic point
Pm: Number of characteristic points included in a class to which the m-th characteristic point belongs in a distribution in the x-direction
Qm: Number of characteristic points included in a class to which the m-th characteristic point belongs in a distribution in the y-direction
n: Total number of characteristic points

By employing the distribution condition for weighting in this way, in the present embodiment, it is possible to reduce the influence from characteristic points of an irregular vector in view of the overall motion of a captured image, as well as to calculate a vector of a captured image showing the overall motion of the captured image appropriately. In other words, in the panorama image generation processing, data of a single panorama image is generated by combining image data captured consecutively. On the other hand, in a case of a moving object such as a human being included in a capturing area, characteristic points of the moving object may move differently from other characteristic points such as those of a landscape, etc. Since the movement of characteristic points of such a moving object shows an irregular vector different from the movement of other characteristic points (the movement substantially following the overall movement of the captured image), it is possible to reduce a degree of influence from an irregular vector by calculating a weighted average by weighting using the number of similar vectors, as compared to a case of simply calculating an average.

It should be noted that the moving amount calculation unit 553 may calculate a vector of a captured image based on the formulae 1 and 2 after excluding vectors of characteristic points that do not satisfy a predetermined threshold of magnitude among the vectors of the plurality of characteristic points. That is to say, characteristic points of an irregular vector may be excluded from the target for arithmetic operations. At this time, the vectors of characteristic points that do not satisfy a predetermined threshold, for example, may not satisfy a predetermined threshold of the magnitude of a vector such as a vector for which the magnitude greatly differs from the overall average value or a vector for which the magnitude greatly differs from the magnitude of vectors defined in a class in which the most characteristic points are classified, or the number of characteristic points belonging to the same class may not satisfy a predetermined threshold such as a vector of characteristic points for which the number of characteristic points belonging to the same class is only one or a vector of characteristic points for which the number of characteristic points belonging to the same class is less than a predetermined percentage of the entirety.

The adjustment unit 55 adjusts a composite image between adjacent captured images based on the vectors of the captured images calculated based on the formulae 1 and 2 of such a moving amount calculation unit 553. That is to say, the adjustment unit 55 arranges the n+1-th captured image at a position, which is moved in the x-direction by “X_{GMV}” as well as in the y-direction by “Y_{GMV}” relative to the n-th captured image.

The panorama image generation unit 56 combines the respective data of captured images that the adjustment unit 55 adjusted to generate panorama image data. Furthermore, the panorama image generation unit 56 stores the panorama image data thus generated in the image storage unit 53.

In this way, since the adjustment of adjacent captured images is performed by performing an arithmetic operation one time based on the formulae 1 and 2 in the present embodiment, it is not necessary to repeat a predetermined arithmetic operation such as in conventional RANSAC method. Here, in order to combine the respective data of a plurality of captured images in the panorama image generation processing, it is necessary to perform the adjustment of adjacent captured images a plurality of times. In a case of performing the respective adjustments a plurality of times using RANSAC method, which requires repeating a predetermined arithmetic operation, the processing load of the image processing device greatly increases. On the other hand, it is possible to reduce the processing load of the image processing device 1 by using a configuration that performs the respective adjustments with a one-time arithmetic operation as in the invention of the present application.

Incidentally, since RANSAC method repeats an arithmetic operation and specifies a transformation matrix of the most appropriate characteristic points, it is possible to adjust a composite position between adjacent captured image accurately. In this regard, although the adjustment of the image processing device 1 of the present embodiment performs a predetermined weighting, the accuracy thereof deteriorates compared to RANSAC method. Therefore, the adjustment of the present embodiment is suitably used for panorama photography in which the digital camera is moved only in a single direction. That is to say, it is preferable to employ the adjustment by the image processing device 1 of the present embodiment in a case in which the panorama photography direction is in a single direction such as a horizontal direction, a vertical direction, or a diagonal direction. On the other hand, it is preferable to employ the highly accurate RANSAC method in a case of photographing a wide-angle image for which the photography direction includes a horizontal direction and a vertical direction so as to make a U-shaped movement. In this way, by employing adjustment by the image processing device 1 of the present embodiment for the panorama image generation processing in the case of moving in a single direction, it is possible to reduce the processing load of the image processing device 1 while performing the adjustment without deteriorating the accuracy.

It should be also noted that the vectors in both the x-direction and y-direction in a captured image are calculated with the abovementioned formulae 1 and 2. This is because a slight movement in a direction orthogonal to a panorama photography direction always occurs, even while moving in a single direction due to hand shaking, etc.

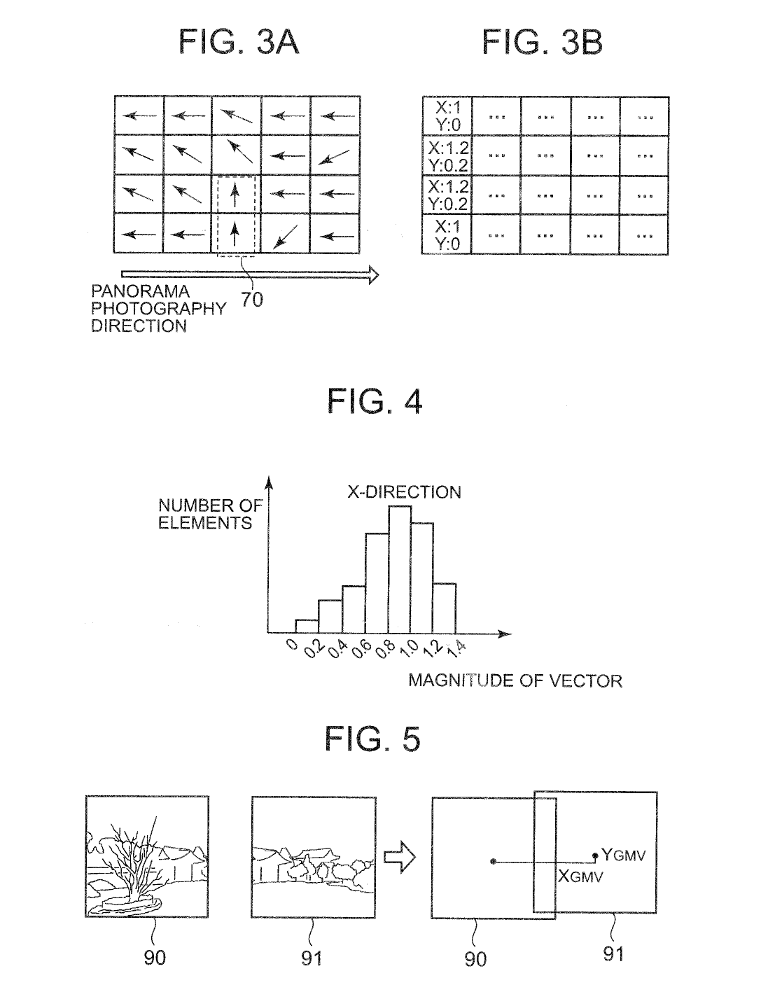

Next, executed functions of the panorama image generation processing are specifically explained with reference to FIGS. 3A, 3B, 4, and 5.

FIGS. 3A and 3B are charts illustrating a function of the adjustment unit 55 of the image processing unit 14. FIGS. 3A and 3B are views illustrating a calculation of vectors of characteristic points by the characteristic point tracking unit 551 of the adjustment unit 55. FIG. 4 is a chart illustrating calculation of a distribution condition of characteristic points by the distribution calculation unit 552. Furthermore, FIG. 5 provides views illustrating the adjustment of adjacent captured images 90 and 91 by the adjustment unit 55.

The characteristic point tracking unit 551 detects a plurality of characteristic points each time the image acquiring unit 54 acquires data of a captured image and calculates a vector of a characteristic point by comparing the corresponding characteristic point in an adjacent captured image. Furthermore, FIG. 3A is a view schematically illustrating a vector of a plurality of characteristic points between adjacent captured images and FIG. 3B is a view schematically illustrating a content of a vector of the respective characteristic points. With reference to FIG. 3A, the panorama photography direction is the right direction from the left side in FIG. 3A, and many characteristic points move in a direction substantially opposite to the panorama photography direction. On the other hand, the characteristic points denoted by the reference number 70 in FIG. 3A can be recognized as moving in a direction unrelated to the panorama photography direction.

Upon the characteristic point tracking unit 551 calculating the vectors of characteristic points between adjacent captured images, the distribution calculation unit 552 calculates a distribution condition of vectors of the characteristic points thus calculated. The calculation of the distribution condition can be done by employing a histogram as shown in FIG. 4, for example. In FIG. 4, the histogram is classified into a plurality of classes based on the magnitudes of vectors, and more specifically, classified into a plurality of classes by increments of “0.2”. It should be noted that, in FIG. 4, a distribution condition is calculated for only an x-direction of the vectors of characteristic points by way of the histogram, and that of a y-direction is not illustrated in FIG. 4. It should also be noted that, in FIG. 4, the difference between the maximum value and the minimum value of vectors is set to be divided into seven, for the sake of explanation. When calculating the distribution conditions as shown in FIG. 4, many characteristic points have vectors corresponding to the panorama photography direction; whereby it is found that, even if there were characteristic points of irregular vectors, the number thereof would be small.

When the distribution calculation unit 552 calculates a distribution condition of vectors of characteristic points between adjacent captured images, the moving amount calculation unit 553 calculates a vector of a captured image between the adjacent captured images based on the formulae 1 and 2. At this time, since weighting is performed based on the distribution condition in the abovementioned formulae 1 and 2, it is possible to reduce the degree of influence from irregular vectors, thereby enabling the trend of overall movement of the captured image to be understood.

By calculating a representative vector (X_{GMV}, Y_{GMV}) of captured images for adjacent captured images in this way, the adjustment unit 55 adjusts a composite position between the adjacent captured images 90 and 91 based on the vector of the captured image calculated as illustrated in FIG. 5.

Then, the panorama image generation unit 56 combines the adjacent captured images based on a result of the adjustment to generate data of a panorama image.

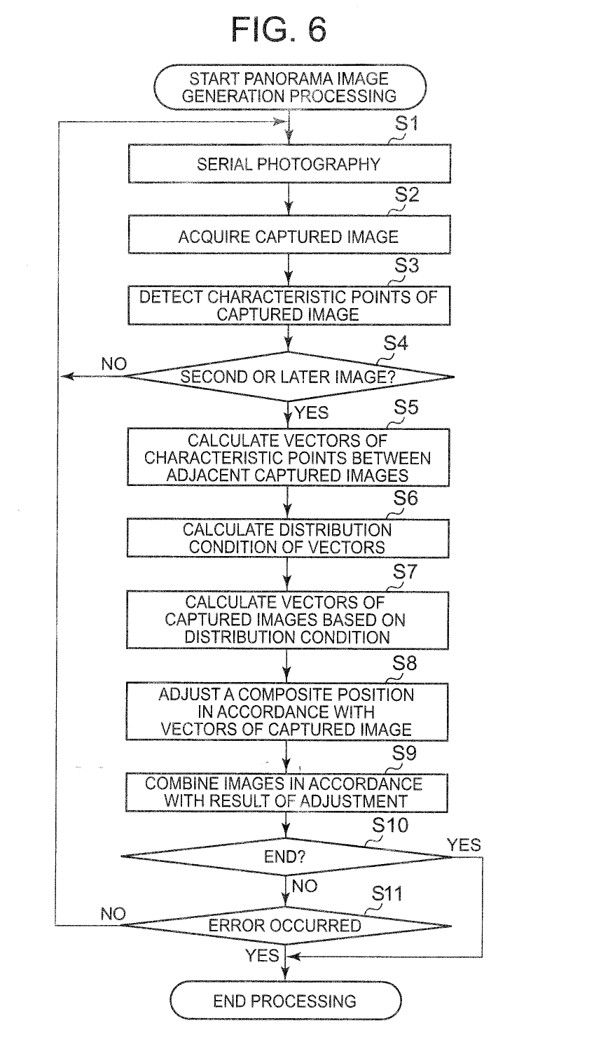

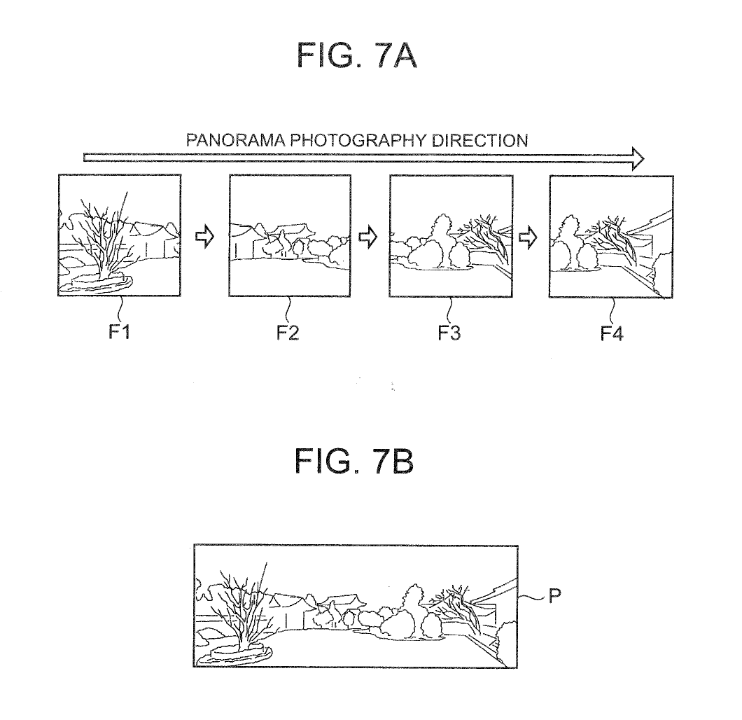

Next, the panorama image generation processing is explained with reference to FIG. 6. FIG. 6 is a flowchart illustrating a flow of the panorama image generation processing executed by the image processing device 1 having the functional configuration of FIG. 2.

It should be noted that the panorama image generation processing starts when an operation of starting the panorama image generation processing to the input unit 18 by a user is started, i.e., when a pressing operation of a shutter button is started.

In Step S1, the image capture control unit 51 controls the image capture unit 17 to perform serial photography.

In Step S2, the image acquiring unit 54 acquires captured image data each time the image capture unit 17 photographs. At this time, the image acquiring unit 54 temporarily stores the captured image data thus acquired in the image storage unit 53.

In Step S3, the characteristic point tracking unit 551 detects a plurality of the characteristic points from the captured image data acquiring in the processing of Step S2 and temporarily stores in the image storage unit 53.

In Step S4, the characteristic point tracking unit 551 determines whether the captured image on which the processing of Step S3 was performed is an image after the first image. In a case of being the second or later captured image, it is determined as YES in Step S4 and the processing advances to Step S5. In a case of not being the second or later, i.e., in a case of being the first captured image, it is determined as NO in Step S4 and the processing returns to Step S1.

In Step S5, the characteristic point tracking unit 551 calculates vectors of a plurality of characteristic points between adjacent captured images by extracting from the image storage unit 53 characteristic points in adjacent captured images (captured imaged previously captured), and then comparing the corresponding characteristic points between the adjacent captured images.

In Step S6, the distribution calculation unit 552 classifies the vectors of the plurality of characteristic points calculated in the processing of Step S5 based on the magnitudes of the vectors and calculates the distribution condition. In this processing, the distribution calculation unit 552 classifies the difference between the maximum value and the minimum value of the vectors based on 64 divided classes and calculates the distribution condition.

In Step S7, the moving amount calculation unit 553 employs the distribution condition calculated in the processing of Step S6 as weighting and calculates the vector of the captured image. More specifically, the moving amount calculation unit 553 calculates the vector of the captured image based on the abovementioned formulae 1 and 2.

In Step S8, the adjustment unit 55 adjusts the composite position between the adjacent captured images in accordance with the vector of the captured image calculated in the processing of Step S7.

In Step S9, the panorama image generation unit 56 combines the respective data of the captured images adjusted by the processing of Step S8 to generate panorama image data.

In Step S10, the CPU 11 determines whether to end the panorama image generation processing. For example, when a digital camera moves more than a predetermined amount or in a case of receiving a predetermined end operation from a user, the CPU 11 determines to end the panorama image generation processing. When it is determined as YES in Step S10, the storage control unit 52 stores the panorama image data generated thus far in the image storage unit 53 and ends the panorama image generation processing. When it is determined as NO in Step S10, the processing advances to Step S11.

In Step S11, the CPU 11 or the image processing unit 14 determines whether an error has occurred or not. For example, when the digital camera has moved more than a predetermined amount in a direction orthogonal to the panorama photography direction (i.e. when the hand shake is large), when a sufficient number of characteristic points cannot be detected from a captured image, or when the calculation of vectors of characteristic points between adjacent captured images cannot be made for a sufficient number of characteristic points, for example, the CPU 11 or the image processing unit 14 determines that an error has occurred. When it is determined as YES in Step S11, the panorama image generation processing ends, and when it is determined as NO in Step S11, the processing advances to Step S1.

In the panorama image generation processing, establishing the panorama photography direction as a single direction and employing captured image data supplied from the image capture unit 17 as a processing target, the image processing device 1 configured as above includes: the adjustment unit 55 that adjusts a composite position between adjacent captured images; and the panorama image generation unit 56 that combines the adjacent captured images based on a result of the adjustment by the adjustment unit 55 so as to generate panorama image data. At this time, the adjustment unit 55 includes: the characteristic point tracking unit 551 that calculates the vectors of a plurality of characteristic points between the adjacent captured images; the distribution calculation unit 552 that calculates a distribution condition of the vectors of the plurality of characteristic points thus calculated; and the moving amount calculation unit 553 that calculates the vector of a captured image between the adjacent captured images.

That is to say, in the present embodiment, the adjustment unit 55 adjusts the composite position between the adjacent captured images by calculating the vector of the overall captured image from the vectors of the plurality of characteristic points; however, the calculation of this vector of the overall captured image is realized by simply performing weighting based on the distribution condition on the vectors of the plurality of characteristic points. In this way, it becomes possible to calculate a vector of an overall captured image without repeating a complicated arithmetic operation, as well as being able to reduce processing load. At this time, since the image processing device 1 employs such an adjustment method for the panorama image generation processing, which sets the panorama photography direction as a single direction, it is not necessary have concern over the deterioration in adjustment accuracy caused from the reduction in the processing load.

At this time, although a calculation of distribution condition used for weighting can be done by an arbitrary method, in the present embodiment, as an example, each of the plurality of characteristic points is classified into a plurality of classes based on the magnitude of the vector of the characteristic point, and the numbers of characteristic points belonging to the same class, respectively, are calculated as a distribution condition. In other words, a distribution condition of the magnitudes of the vectors of the characteristic points is calculated using the histogram illustrated in FIG. 4.

By weighting using such a distribution condition, it is possible to calculate a vector of an overall captured image by increasing the degree of influence from a vector which is similar in many characteristic points and reducing a degree of influence from an irregular vector.

Furthermore, the plurality of classes classifying the characteristic points can be arbitrarily set. For example, the distribution calculation unit 552 may set the width of a class to be wider if the maximum value and the minimum value between vectors of characteristic points differ greater, and may set the width of a class to be narrower if the maximum value and the minimum value are proximate.

In this way, it is possible to further reduce a degree of influence from an irregular vector.

Furthermore, weighting based on a distribution condition can be done by an arbitrary method so long as repetitive arithmetic operations are not needed. In the present embodiment, as an example thereof, a weighted average is employed which uses the number of characteristic points belonging to the same class as a weight as indicated by the abovementioned formulae 1 and 2.

In this way, it is possible to calculate a vector of a captured image in a one-time arithmetic operation, and it is possible to reduce the processing load as well as maintain the adjustment accuracy.

Furthermore, although it is possible to reduce a degree of influence of an irregular vector by employing a distribution condition as weighting, the image processing device 1 of the present embodiment may exclude irregular vectors when calculating the vector of a captured image. Therefore, among a plurality of vectors of characteristic points, the moving amount calculation unit 553 may exclude a vector of a characteristic point that does not satisfy a predetermined threshold and calculate the vector of a captured image.

In this way, it is possible to further reduce a degree of influence from an irregular vector.

Although the image processing device 1 of the present embodiment has been explained above, the present invention is not limited to the aforementioned embodiment, and modifications, improvements and the like within a scope that can achieve the object of the present invention are included in the present invention.

In the aforementioned embodiment, the adjustment and the combination of adjacent captured images are performed each time captured image data is acquiring in the panorama image generation processing; however, the adjustment and the combination may be performed together after acquiring all of the captured image data to generate panorama image data.

Furthermore, in the abovementioned embodiment, although the image processing device 1 to which the present invention is applied is explained with the example of a digital camera, the present invention is not limited thereto.

For example, the present invention can be applied to common electronic equipment having a panorama image generation function. More specifically, the present invention can be applied to a notebook-type personal computer, a printer, a television receiver, a video camera, a portable navigation device, a cell phone, a portable game machine, and the like.

The aforementioned sequence of processing can be made to be executed by hardware, or can be made to be executed by software.

In other words, the functional configuration in FIG. 2 is merely an exemplification, and the present invention is not particularly limited thereto. More specifically, it is sufficient so long as the functions enabling execution of the aforementioned sequence of processing as a whole are imparted to the image processing device 1, and what kind of functional blocks are used in order to realize these functions are not particularly limited to the example of FIG. 2.

In addition, one functional block may be configured by a single piece of hardware, configured by a single piece of software, or may be configured by a combination of these.

In the case of having the sequence of processing executed by way of software, a program constituting this software is installed from the Internet or a recording medium into a computer or the like.

The computer may be a computer incorporating special-purpose hardware. In addition, the computer may be a computer capable of executing various functions by installing various programs, for example, a general-purpose personal computer.

The recording medium containing such a program may be configured not only by the removable media 31 of FIG. 1 that is distributed separately from the main body of the device in order to provide the program to the user, but also is configured by a recording medium provided to the user in a state incorporated in the main body of the equipment in advance, or the like. The removable media 31 is constituted by, for example, a magnetic disk (including floppy disks), an optical disk, a magneto-optical disk or the like. The optical disk is, for example, a CD-ROM (Compact Disk-Read Only Memory), DVD (Digital Versatile Disk), or the like. The magneto-optical disk is, for example, an MD (Mini-Disk), or the like. In addition, the recording medium provided to the user in a state incorporated with the main body of the device in advance is constituted by the ROM 12 of FIG. 1 in which a program is recorded, a hard disk included in the storage unit 20 of FIG. 1, or the like.

It should be noted that the steps describing the program recorded in the recording medium naturally include processing performed chronologically in the described order, but is not necessarily processed chronologically, and also includes processing executed in parallel or separately.

In addition, in the present specification, the terminology of system shall mean an overall device configured from a plurality of devices, a plurality of means, and the like.

Although several embodiments of the present invention have been explained in the foregoing, these embodiments are merely examples, and do not limit the technical scope of the present invention. The present invention can be attained by various other embodiments, and further, various modifications such as omissions and substitutions can be made in a scope not departing from the spirit of the present invention. These embodiments and modifications thereof are included in the scope and gist of the invention described in the present specification, etc., and are encompassed in the invention recited in the attached claims and equivalents thereof.

What is claimed is:

1. An image analysis device comprising:
an acquiring unit that acquires a first image and a second image captured by an image capture unit, while the image capture unit is moved substantially in a single direction;
a vector calculation unit that, for a plurality of characteristic points included in each of the images acquired by the acquiring unit, calculates vectors between the images having the characteristic points;
a distribution calculation unit that calculates a distribution condition of the vectors calculated by the vector calculation unit; and
a representative vector calculation unit that calculates a representative vector for adjusting a composite position between the images, by weighting vectors calculated by the vector calculation unit based on a calculation result of the distribution calculation unit.

2. The image analysis device according to claim 1,
wherein the distribution calculation unit includes a classification unit that classifies a plurality of characteristic points into a plurality of classes based on magnitudes of the vectors, and calculates the number of characteristic points belonging to each of the classes classified by the classification unit as the distribution condition.

3. The image analysis device according to claim 1,
wherein the representative vector calculation unit calculates a representative vector between the images by calculating a weighted average of the vectors using the number of the characteristic points belonging to the same class as a weight.

4. The image analysis device according to claim 2,
wherein the distribution calculation unit determines each of the plurality of classes based on an extent of difference between a minimum value and a maximum value of the vectors calculated by the vector calculation unit.

5. The image analysis device according to claim 1,
wherein the representative vector calculation unit calculates the representative vector by excluding, between vectors calculated by the distribution calculation unit, a vector not satisfying a predetermined threshold.

6. An image processing device comprising:
the image analysis device according to claim 1;
an adjustment unit that adjusts the composite position between the images based on a representative vector calculated by the representative vector calculation unit; and
a generation unit that generates a composite image by combining the adjusted images.

7. An image processing method executed by an image processing device, the method comprising the steps of:
acquiring a first image and a second image captured by an image capture unit, while the image capture unit is moved substantially in a single direction;
for a plurality of characteristic points included in each of the images acquired by the acquiring unit, calculating vectors between the images having the characteristic points;
calculating a distribution condition of the vectors calculated by the vector calculation unit; and
calculating a representative vector for adjusting a composite position between the images, by weighting vectors calculated by the vector calculation unit based on a calculation result of the distribution calculation unit.

8. A storage medium encoded with a computer-readable program that enables a computer to execute functions as:
an acquiring unit that acquires a first image and a second image captured by an image capture unit, while the image capture unit is moved substantially in a single direction;
a vector calculation unit that, for a plurality of characteristic points included in the images acquired by the acquiring unit, calculates a vector between the images having the characteristic points;
a distribution calculation unit that calculates a distribution condition of the vectors calculated by the vector calculation unit; and
a representative vector calculation unit that calculates a representative vector for adjusting a composite position between the images, by weighting vectors calculated by the vector calculation unit based on a calculation result of the distribution calculation unit.
